(19) United States
(12) Patent Application Publication
(10) Pub. No.: US 2006/0165857 A1
(43) Pub. Date: Jul. 27, 2006

(54) Bakery product which is protected against spoilage and process for preventing mould spoilage of bakery products

(76) Inventors: Graham Williams, Halstock (GB); Joss Delves-Broughton, Sherborne (GB); John Faragher, Richfield, WI (US); Jay Hardy, Boise, ID (US); Kersti Haugan, Vejle (DK); Linda V. Thomas, Dorchester (GB); Peter Wisler, Kuala Lumpur (MY)

Correspondence Address: STEPTOE & JOHNSON LLP, 1330 CONNECTICUT AVENUE, N.W., WASHINGTON, DC, 20036, US

(21) Appl. No.: 11/041,942

(22) Filed: Jan. 26, 2005

(51) Int. Cl. A23B 7/16; A23F 5/00

(52) U.S. Cl. 426/310

(57) ABSTRACT

The present invention relates to a bakery product, which is protected by natamycin against spoilage, as well as to a process for preventing mould spoilage of bakery products. The viscosity of the natamycin suspension is increased by a thickener before it is sprayed onto the bakery product. The thickener ensures that the natamycin is evenly distributed on the surface of the bakery product.

### BACKGROUND OF THE INVENTION

The present invention relates to a bakery product which is protected against spoilage and to a process for preventing mould spoilage of bakery products.

Many industrially produced baked goods emerge from the baking process with a surface that is essentially sterile but post bake handling can quickly lead to fungal surface contamination as a result of exposure to airborne contaminants as well as equipment contact. Following surface contamination, many baked goods are then very vulnerable to surface mould spoilage, the severity of which is linked to factors such as the degree of contamination, the moisture content of the product and the storage conditions. Baked products with a relatively neutral pH, high moisture content and high water activity such as breads, cakes, pastry, muffins, waffles, tortillas, pizzas, doughs as well as many part-baked products are particularly prone to rapid spoilage from a variety of moulds, principally Penicillium and Aspergillus species. Manufacturing good tasting bakery products with a long mould free shelf life presents a constant and ongoing technical challenge to the baking industry.

Various methods have been adopted in an attempt to prevent mould spoilage. These include addition of humectants to reduce the water activity, addition of chemical mould inhibiting preservatives such as propionates or sorbates, limiting the availability of oxygen via modified atmosphere packaging and active packaging containing oxygen scavengers or providing a saturated ethanol headspace in the pack using sachet or strip inserts containing ethanol. The chemical preservatives such as sorbate and propionate are most effective at low pH so acids are often added in combination with these preservatives to reduce the pH of the baked product and hence improve the effectiveness of the added preservative.

Addition of acids, chemical preservatives and humectants can affect the taste and quality of the product and their use is often a compromise between achieving the best tasting product and the longest possible shelf life. Preservation based on packaging systems rely very much on pack integrity and even the best systems can suffer shelf life failures due to pack damage or seal failures and hence loss of pack integrity. Thus, there remains the technical problem of providing an efficient preservation system, which will not adversely affect the taste of baked goods.

Natamycin is a polyene macrolide natural anti-fungal agent produced by fermentation of the bacterium Streptomyces natalensis. Natamycin (previously known as pimaricin) has an extremely effective and selective mode of action against a very broad spectrum of common food spoilage yeasts and moulds with most strains being inhibited by concentrations of 1-15 ppm of natamycin.

Natamycin has been used for many years in a large number of countries throughout the world as an authorized preservation treatment for cheeses and certain meat products such as dried sausages. Despite this long-term use, the development of resistant strains has not been reported to date unlike the chemical organic acid sorbate and propionate preservatives for which a number of resistant yeasts and moulds have been detected and reported. Some species of Penicillium mould are even able to degrade and metabolise sorbate.

Natamycin is much less soluble in water than the chemical organic acid preservatives with its maximum solubility being around 40 ppm. In practice this means that when applied to the surface of the cheese or sausage, natamycin shows very limited diffusion and tends to stay on the surface of the food. Natamycin is active over a wide pH range and unlike the organic acid preservatives it is not dependant on a low pH acidic environment to show good anti-fungal activity. The effectiveness of natamycin at very low application levels on cheese and sausage has not been reported to have any adverse quality or flavour impact on the products.

Although natamycin has been used for a long time on cheese and on sausages, there is very little reported on the use of natamycin for other types of food. According to a review article “Antibiotics in Food: Primarcin” in the Encyclopaedia of Food Technology Volume 2. 1974, The Avi Publishing Co. Inc. Westport, Connecticut, USA, pp 36-37, Eds. A. H. Johnson and M. S. Peters, natamycin (pimaricin) is permitted in several countries as a food additive and it is either added into the food (e.g. orange juice, wine) or the food is dipped, soaked or sprayed with aqueous natamycin (e.g. cheese, sausage, fruit). Natamycin has also been used in combination with thickening agents on cheeses and sausages as described in the U.S. Pat. No. 5,552,151 and U.S. Pat. No. 5,962,510, as well as in WO 03/101213 and EP 0 867 124.

U.S. Pat. No. 2004/0013781 discloses a fully baked bread product which remains soft for an extended shelf life. The bread may be protected by a microbial inhibitor which may be natamycin. In the described embodiments the inhibitor is included in the dough at baking. However, there is also a suggestion that a potassium sorbate inhibitor may be sprayed in an aqueous solution on the bread after baking.

Natamycin has been proposed for use for increasing the shelf life of fine bakery products which have an intermediate or high moisture (U.S. unpublished application 10/765,210).

In the U.S. the direct addition of natamycin into tortilla dough before baking is allowed. Tortilla dough is leavened without yeast and therefore adding natamycin into the tortilla dough is possible. In yeast leavened doughs, natamycin cannot be used since the natamycin would kill the yeast. Because of this limitation of using natamycin in yeast leavened bakery, natamycin seems to have been tested on the surface of yeast leavened bread. Thus, the review in the above mentioned 1974 Encyclopaedia also mentions that “rye and white bread were well protected when their surfaces were sprayed with a solution of 100-500 ppm pimaricin”. No specific results are quoted to support the “well protected”comment and no reference is quoted for this work. No target levels for natamycin/pimaricin on the surface of the bread are given, no method of spraying and no shelf life targets are mentioned. In a later update of this review article for the same Encyclopaedia there was no mention of this bakery work. The review also makes similar vague references to treating the surface of uncooked doughs and to direct addition at 25-50 ppm in fillings for cakes and pies.

The direct addition of natamycin into icings and fillings of cakes is described also by J. Tichá Mlynsko-pekarensky promysl, 7/1975, pp 225-228, as being effective in preventing the growth of moulds and yeasts for about 14 days. The article concludes that natamycin in admixture with lactose is useful to preserve curd fillings, icings and butter creams.

The use of natamycin to protect the surface of the fillings of Cantonese mooncakes and pastry is allowed according to Chinese legislation. However, the mooncakes themselves often have a fairly low water activity and are thus not as prone to spoil as the fillings, which are often made of easily perishable foodstuffs.

Many bakery products are required to have a very long shelf life. Intermediate and high moisture fine bakery products such as cakes (including Danish pastries), pastry, muffins, waffles, pancakes, tortillas, pizza bases, sponge cakes and the like are usually packaged and kept at ambient temperatures on the shelf for 2 to 10 weeks and sometimes longer. Yeast-leavened baked goods, such as bread (also including rolls, hamburger buns, baguettes), tend to go stale in a much shorter period and the shelf life of most bread is normally not above two weeks. However, especially in warm environments where spoilage takes place very fast, bakery products such as breads and part-baked and non-baked bakery products, also need an improved shelf life and better protection against spoilage by moulds.

The high water content of many bakery products makes them very sensitive to spoilage due to mould and yeast growth. This is especially true when the water activity of the product a_{w} is 0.8 or more, especially 0.85 or more. In an attempt to protect intermediate moisture and high moisture baked goods from mould growth, natamycin was added into tortilla dough, as allowed by the U.S. regulations, and into the pastry dough and egg glaze of Chinese mooncakes pre-baking. However, surprisingly, the attempts failed and did not result in any significant improvement of the shelf life of the baked goods. It was found that incorporating natamycin within the baked good was unsuccessful despite the fact that natamycin levels, which would normally be considered effective against yeasts and moulds, could still be detected in the goods after the baking process.

In two separate trials where natamycin was incorporated into tortillas, the control of surface mould growth during shelf life was not achieved. Analysis of the mouldy tortillas from both trials showed that natamycin was still present within the tortillas at levels between 14.0 and 28.0 ppm. These relatively high levels of residual natamycin would normally be expected to show good control of mould growth indicating that the natamycin present within these tortillas was not biologically available at the surface of the product where it is required to be effective.

Spraying of an aqueous dispersion of natamycin on the surface of baked goods in accordance with the above mentioned U.S. application Ser. No. 10/765,210 was effective in preventing mould growth in most cases. However, when natamycin was used on the surface of some bakery products in order to prevent spoilage, it was noticed that when the natamycin was sprayed on the surface, the distribution of the natamycin could become uneven as some of the natamycin collected as pools in crevices of the surface.

Consequently, natamycin sprayed on the bakery products was not always effective since some parts of the product did not have sufficient natamycin on the surface and in some parts of the product the sprayed natamycin formed pools.

Documents cited in this text (“herein cited documents”), as well as each document or reference cited in each of the herein-cited documents, and all regulations, manufacturer's literature, specifications, instructions, product data sheets, material data sheet, and the like, as to each product mentioned in this text, are hereby expressly incorporated herein by reference.

### BRIEF SUMMARY OF THE INVENTION

The present invention is based on the realization that when natamycin is sprayed on a surface of a bakery product using a suspension which contains natamycin and a natamycin suspension thickener, the natamycin is evenly distributed on the surface of the product and does not collect in the crevices of the surface.

Thus, the present invention provides a bakery product which is protected by natamycin against spoilage, said bakery product having evenly distributed on the surface thereof an effective mould growth inhibiting amount of natamycin and a natamycin suspension thickener.

Thus, the present invention provides a bakery product the surface of said bakery product having deposited thereon an evenly distributed and effective amount of natamycin which is sufficient to protect all parts of said product against mould growth.

The present invention also provides a process for preventing mould spoilage of bakery products, comprising providing a bakery product which is susceptible to mould growth; providing a suspension of natamycin which includes a suspension thickener; and spraying the outer surface of said bakery product with said natamycin suspension to distribute an effective mould growth inhibiting amount of natamycin and thickener evenly on said surface. The natamycin deposited on the surface of said bakery product is provided in an amount which is effective in protecting said product against mould growth. The present invention provides a significant increase in the expected shelf life of the bakery product. The shelf life increase is preferably 100% and often even more.

The preferred bakery product is selected from the group consisting of baked, part-baked and unbaked bakery products. The preferred bakery products protected by the invention are selected from bread products, fine bakery and bakery-based food products, which may all be yeast-leavened or non yeast-leavened. Typical bakery products of the invention are cakes (including Danish pastries), muffins, waffles, pancakes, tortillas, pizza bases, doughs (part-baked and unbaked), pastry, toastbread, rolls, hamburger buns, baguettes and the like bakery products.

The increase of mould-free shelf life achieved by the present invention is of great significance to the baking industry and will allow the replacement of chemical preservatives such as propionate, benzoate and sorbate with natamycin, a less toxic, tasteless and naturally occurring alternative. The belief that natamycin is not an effective preservative for baked goods (based on evidence of lack of efficacy when incorporated into the food prior to baking), has been shown to be false and has been overcome by the present invention by spraying the natamycin as a suspension containing a natamycin and a natamycin suspension thickener onto the products. Even though this requires prospective users to invest in suitable spraying equipment that can deliver an even natamycin application to all surfaces of bakery products, the advantages of natamycin are seen to outweigh the disadvantages of its use.

### DETAILED DESCRIPTION OF THE INVENTION

The present invention is based on the finding that uneven distribution of natamycin and pooling on the sprayed surface is avoided by spraying the natamycin as a suspension which contains also a suspension thickener.

Bakery products have uneven horizontal surfaces where the sprayed suspension easily forms pools. Spraying cheeses or sausages do not have such problems. Shredded cheese is tumbled and no pooling can occur. Sausages on the other hand have an even surface and they are hanged which prevents pooling.

Consequently, the invention provides a bakery product with improved mould resistance through the use of a natamycin suspension including a thickener on the surface of said product. In the invention the natamycin is deposited on said surface in a suspension which includes a thickener. The thickener is preferably selected from the group consisting of agar, alginates, carrageenan, cellulose and derivatives, gums, gelatin, pectins and derivatives thereof, polyvinyl acetate, starches and modified starches, and suspending agents. Useful derivatives of cellulose are such as microcrystalline cellulose sodium, hydroxypropylmethyl cellulose, carboxymethyl cellulose and methyl cellulose. The gums used are e.g. xanthan gum, gellan gum, locust bean gum, gum arabic, gum tragacanth, gum karaya, guar gum, rhamxam gum, conjac gum and seed gum. Suspending agents used are e.g. sodium dodecyl sulphate, polyethylene glycol, fumed silica, glycol and glycerol.

The thickener increases the viscosity of the spraying suspension. The thickener used in the suspension ensures that the sprayed natamycin remains evenly distributed at the point of deposition and does not collect in pools in the crevices of the bakery goods which is possible when natamycin is sprayed on the surface without using a thickener. Moreover, the thickener produces a gel which prevents or reduces the sedimentation of natamycin in the suspension. Consequently, the natamycin is better distributed in the thickened suspension and therefore also in the spray and this leads to an even distribution on the surface of the bakery product.

The present invention is applicable to be used in various types of bakery products. The present invention is primarily used for bakery product selected from the group consisting of baked, part-baked and unbaked bakery products. The preferred bakery products protected by the invention include bread products, fine bakery and bakery-based food products, which may all be yeast-leavened or non yeast-leavened. Preferred bakery products of the invention are cakes (including Danish pastries), muffins, waffles, pancakes, tortillas, pizza bases, doughs (part-baked and unbaked), pastry, toastbread, rolls, hamburger buns, baguettes and the like bakery products. The bread products of the invention may be sliced or unsliced, sweetened or non-sweetened.

The preferred bakery products are products intended for a long shelf life and having a moisture content which makes them susceptible to surface spoilage by moulds and yeasts. Such bakery products are especially intermediate or high moisture bakery products having a water activity a_{w}>0.8, preferably 0.85 or more. A moisture content of 0.8 to 0.85 is regarded herein as an intermediate moisture content, while a moisture content above 0.85 is regarded as a high moisture content. Typical examples of such bakery products are the bakery products mentioned above. The bakery based food products include ready made food products such as pizzas in addition to pizza bases.

The surface of the bakery product of the invention has deposited thereon an effective amount of natamycin which is sufficient to keep the product free of mould and yeast growth significantly longer than its storage time without natamycin. The surface of the product also contains the thickener dried on the surface. The product will typically be packaged and stored for a time of 1 to 2 weeks or more. The effective amount of natamycin on the surface of the finished product is typically between 0.5 and 10 μg per cm², preferably from 3 to 5 μg per cm², and it is sufficient for keeping the bakery product mould free for 1 to 10 weeks, preferably for 3 to 10 weeks, or even longer, when the product is stored at ambient temperature such as 15 to 30° C. or chilled at 2 to 15° C.

The amount of the natamycin thickener on the bakery product depends on the amount of thickener used in the spray suspension relative to the amount of natamycin. The amount of thickener on said surface is typically from 0.5 μg to 0.5 g per cm². The amount of thickener will depend on the effectiveness of the specific thickener used. Some thickeners, like xanthan gum, are especially effective in preventing sedimentation and preventing blocking of spray nozzles. Others, such as HPMC (hydroxypropylmethyl cellulose), require slightly higher levels of thickener for providing the same effect.

When the process of the present invention is operated, the outer surface of a bakery product is sprayed with a suspension containing natamycin and a suspension thickener. The spraying should be performed so that an effective amount of natamycin is deposited on the exposed surface of the product. The thickened natamycin suspension is sprayed onto the exposed surface in the form of an aqueous suspension containing natamycin as dissolved natamycin and also in solid, crystalline, non-dissolved form. Crystalline natamycin is sparingly soluble in water and the finely divided solid natamycin crystals will be deposited on the surface of the bakery product together with the water, the dissolved thickener and the dissolved natamycin.

In a preferred embodiment of the present invention the thickener is effective in providing an improved spray of natamycin compared to one provided by a similar natamycin suspension without said thickener.

The thickener increases the viscosity of the natamycin suspension. In that way the thickener is effective in preventing flow of said natamycin once it is deposited on the surface of said bakery product and the distribution of the natamycin is even. Typical viscosities obtainable with thickeners are those mentioned for the handling of cheese or sausages in the above-mentioned U.S. Pat. No. 5,552,151. The optimum viscosity may vary from product to product and the person skilled in the art will be able to add a suitable amount of thickener to his suspension to suit his specific product.

A preferred aqueous natamycin suspension for spraying purposes contains from 150 to 5000 mg natamycin and from 100 to 50000 mg thickener per liter of water. A preferred natamycin suspension contains 500 to 10000 mg/l thickener. An especially preferred natamycin suspension is an aqueous suspension containing 1000 to 2500 mg/l natamycin and from 500 to 3000 mg/l of HPMC.

A commercial HPMC product which has been found especially useful is Methocel F4M (Dow Chemicals). It has been presented previously that HPMC dries too slowly to be used as a thickener, however the present inventors have shown that this is not the case and that HPMC functions advantageously as a thickener for the natamycin suspension.

A typical thickened suspension could be prepared from about 20 to 40% Methocel F4M, 8 to 30% Natamaxm™ SF (Danisco A/S) and made up to 100% of the dry weight with micronised salt (NaCl). When such a product is added to water at a level of about 1%, it will provide a suspension with a natamycin level of 800 to 2600 ppm natamycin. A further addition of 9 to 10% salt is recommended if the suspension is retained under conditions susceptible to bacterial contamination.

A very small amount of natamycin is required to provide the desired protection against spoilage by moulds and yeasts. A deposited amount of from 0.5 to 10 μg natamycin per cm² of the surface of the bakery product has been found to comprise an effective amount. It is of course possible to add more than the required amount of natamycin to the product. A higher amount than the above mentioned will certainly also be effective against mould and yeast growth and as natamycin has no bad taste, the product so protected would still be perfectly edible.

The natamycin suspension should be sprayed homogeneously on all outer surfaces of the bakery product so as to protect the product all over. Natamycin has a very low tendency for migration in the product and will not spread far from the point of deposition. The thickener used in the suspension provides and maintains an even distribution of the suspension on the surface. In order to provide a homogeneous deposition the spraying equipment should be carefully selected. The natamycin based spray suspension is preferably delivered by a spinning disc, pneumatically operated spray gun or any other suitable spraying system that is capable of delivering a small but consistent and accurate spray volume over a given surface area. The thickener has been found to improve the spraying by reducing the blocking of the spray nozzles compared to a similar but unthickened natamycin suspension. The volume of the water based thickened natamycin suspension sprayed onto the product should preferably be kept to the minimum level that will allow an even surface coverage. The natamycin deposited on the surface of the bakery product should, however, be effective in keeping the bakery product mould free significantly longer than its expected shelf life without natamycin.

After spraying, the bakery product is packaged into a protective envelope, which is preferably made of a transparent material such as a plastic film or box to allow the presumptive buyer to view the product and be tempted by it. The films are generally of a moisture proof material to prevent the moist bakery product from drying and loosing its softness during the storing.

The following examples illustrate the invention.

### REFERENCE EXAMPLE

### Natamycin in Mooncakes

Mooncakes are traditional bakery products that are baked and eaten in large numbers once a year in China to celebrate a mid-Autumn festival. The cakes consist of a thin outer layer of pastry covering a variety of paste type fillings that are moulded into intricate shapes prior to baking. The outside of the cake is covered with an egg glaze and part cooked at 200° C.-210° C. for 15 minutes before a second coating of egg glaze is applied ready for the final bake of 10 minutes at the same temperature. Large-scale production, sale and storage of mooncakes begin in the period leading up to the festival and mould problems can occur on the surface of these products prior to consumption.

Two trial production runs of mooncakes containing lotus bean paste were made to test the efficacy of direct natamycin addition prior to baking for preserving these bakery products. The cakes were packed into individual clear plastic bags with no other preservative.

For the first production a range of four increasing natamycin levels (20, 25, 30 and 35 ppm) were mixed into the raw pastry dough for four small separate batches prior to glazing and baking. For the second production, nothing was added to the dough but an increasing range of the same four 20-35 ppm natamycin levels were added to the egg glaze that was applied to the cake surface after the first bake but before the second and final baking stage. Control cakes with no natamycin addition were also prepared.

Representative samples from each batch were assayed for residual natamycin in 10 g samples of the surface pastry layer. Good levels of residual natamycin activity were detected in the surface pastry of all samples from both production runs but despite this the growth of spoilage moulds still appeared on the surface of all of the natamycin treated cakes within 20 -24 days of manufacture.

### Example 1

### Natamycin Suspension on the Surface of Sandwich Bread

Natamycin suspension containing a thickener was tested on the surface of sandwich breads, i.e. bread sliced after baking. The natamycin suspension contained 2800 ppm natamycin and 0.25% of thickener HPMC based on the total weight of the suspension.

Sandwich breads were prepared according to a standard recipe with no added preservative in the dough. Shortly after baking, half of the breads were sprayed whilst still warm with the natamycin suspension. Spraying was done using a pneumatic hand-held spray gun with integral reservoir. The natamycin remained evenly suspended in the thickened suspension without a need for shaking. Each bread was sprayed evenly over all surfaces with a minimum volume of finely adjusted spray.

After cooling, the sprayed breads were sliced and packaged as loaves into heat sealed clear polythene bags. Unopened bags of bread were put for shelf life evaluation at 25° C. and examined daily for signs of surface mould or yeast growth.

Natamycin treated bread samples as well as untreated control bread samples (which had no natamycin sprayed on the surface) were stored at ambient temperature (25° C.). Natamycin treated samples showed no mould after 16 days of storage, whereas the control samples displayed mould qrowth very quickly—after 5 days, as can be seen on the mould observation Table below.

| Days until | Control/untreated | Natamycin |
|---|---|---|
| mould observed | bread | treated bread |
| 1 | 0 | 0 |
| 2 | 0 | 0 |
| 5 | 0 | 0 |
| 6 | 1 | 0 |
| 7 | 2 | 0 |
| 8 | 3 | 0 |
| 9 | 4 | 0 |
| 10 | 4 | 0 |
| 11 | 4 | 0 |
| 12 | 4 | 0 |
| 13 | 5 | 0 |
| 14 | 5 | 0 |
| 15 | 5 | 0 |
| 16 | 5 | 0 |

Scale:
0 = no mould observed
5 = extensive mould spoilage

The table shows quite clearly that the treatment with a natamycin gel suspension prevents mould growth on bread.

### Example 2

### Comparative Example

The effect of the thickened natamycin suspension is tested on waffles. Ten waffles are sprayed with a natamycin suspension in water and ten waffles are sprayed with a natamycin suspension with a thickener as in Example 1. The amount of natamycin applied on the waffles is 5 μg/cm² in each case.

The samples are packaged and stored at ambient temperature. After two weeks all waffles sprayed with the thickened natamycin suspension are still mould free, whereas two of the waffles sprayed with the non-thickened natamycin suspension have areas of visible mould on the up-standing edges where the suspension seems to have flown off.

The above examples clearly demonstrate the preservative efficacy of natamycin when sprayed as a thickened suspension on the outer surface of bakery products, which are susceptible to surface spoilage by moulds and yeasts during storage. Based on the description and examples a person skilled in the art is able to apply the invention to a wide variety of thickened suspensions and bakery goods.

1. A bakery product which is protected by natamycin against spoilage, said bakery product having evenly distributed on the surface thereof an effective mould growth inhibiting amount of natamycin and a natamycin suspension thickener.

2. A bakery product according to claim 1, wherein said natamycin suspension thickener is selected from the group consisting of agar, alginates, carrageenan, cellulose and derivatives, gums, gelatin, pectins and derivatives, polyvinyl acetate, starches and modified starches and/or a suspending agent such as sodium dodecyl sulphate, polyethylene glycol, fumed silica, glycol, glycerol.

3. A bakery product according to claim 2, wherein said derivative of cellulose is selected from the group consisting of microcrystalline cellulose sodium, hydroxypropylmethyl cellulose, carboxymethyl cellulose and methyl cellulose.

4. A bakery product according to claim 2, wherein said gum is selected from the group consisting of xanthan gum, gellan gum, locust bean gum, gum arabic, gum tragacanth, gum karaya, guar gum, rhamxan gum, konjac gum and seed gums

5. A bakery product according to claim 1, wherein said effective amount of natamycin comprises from 0.5 to 10 μg per cm² of the surface of said bakery product.

6. A bakery product according to claim 5, wherein said effective amount of natamycin comprises preferably 3 to 5 μg per cm² of the surface of said bakery product

7. A bakery product according to claim 1, wherein said natamycin suspension thickener is provided in an amount of 0.5 μg to 0.5 g per cm² of the surface of said bakery product.

8. A bakery product according to claim 1, wherein said bakery product is selected from the group consisting of baked, part-baked and unbaked bakery products.

9. A bakery product according to claim 8, wherein said bakery product is selected from the group consisting of bread products, fine bakery and bakery-based food products, which may be yeast-leavened or non yeast-leavened.

10. A bakery product according to claim 9, wherein said bakery products is selected from cakes, muffins, waffles, pancakes, tortillas, pizza bases, part-baked and unbaked doughs, pastry, toastbread, rolls, hamburger buns and baguettes.

11. A bakery product according to claim 1, wherein said bakery product is packaged in a protective envelope.

12. A process for preventing mould spoilage of bakery products, comprising
providing a bakery product which is susceptible to mould growth
providing a suspension of natamycin which includes a suspension thickener
spraying the outer surface of said bakery product with said natamycin suspension to distribute an effective mould growth inhibiting amount of natamycin and thickener evenly on said surface.

13. A process according to claim 12, wherein said suspension thickener comprises a thickener selected from the group consisting of agar, alginates, carrageenan, cellulose and derivatives, gums, gelatin, pectins and derivatives, polyvinyl acetate, starches and modified starches and/or a suspending agent such as sodium dodecyl sulphate, polyethylene glycol, fumed silica, glycol, glycerol.

14. A process according to claim 12, wherein said thickener is effective in preventing flow of said natamycin once it is deposited on the surface of said bakery product.

15. A process according to claim 12, wherein said suspension is an aqueous suspension containing from 150 to 5000 mg natamycin and from 100 to 50000 mg thickener per liter of water.

16. A process according to claim 15, wherein said suspension is an aqueous suspension containing 1000 to 2500 mg/l natamycin and from 500 to 3000 mg/l of hydroxypropylmethyl cellulose.

17. A process according to claim 12, wherein said suspension is an aqueous suspension is prepared using a powder blend containing 20 to 40% HPMC, 8 to 30% natamycin and made up to 100% of the dry weight with salt (NaCl).

18. Use of a stabilized natamycin suspension for improving the distribution of natamycin sprayed onto the surface of a bakery product.
